(19) United States
(12) Patent Application Publication
(10) Pub. No.: US 2020/0125175 A1
(43) Pub. Date: Apr. 23, 2020

(54) SYSTEM USING LOCATION, VIDEO-PROCESSING, AND VOICE AS USER INTERFACE FOR CONTROLLING DEVICES

(71) Applicant: WiSilica Inc., Laguna Hills, CA (US)

(72) Inventors: Dennis Ching Chung Kwan, San Diego, CA (US); Suresh Kumar Singamsetty, Aliso Viejo, CA (US)

(21) Appl. No.: 16/163,408

(22) Filed: Oct. 17, 2018

(51) Int. Cl. G06F 3/01; G06K 9/00; G06T 7/73; G06F 3/16

(52) U.S. Cl. CPC G06F 3/017; G06F 3/167; G06T 7/73; G06K 9/00355

(57) ABSTRACT

A system and method receive a selection input and an action input from different sets of sensors. The inputs are associated with a device, an action is selected for the device, and a control signal is sent to the device to operate the device. The sensors may receive signals including voice commands, gestures, and location information. The system and method may also be applied to select multiple devices and perform actions on each of the devices.

### BACKGROUND

Conventional device operating systems may utilize cameras and processing systems to receive and interpret gestures to determine an action to be performed. However, these conventional systems may be limited to gesture-only controls and do not incorporate further control systems, such as voice commands and location information.

### BRIEF SUMMARY

The present system utilizes three-dimensional (3D) image and video processing as a user interface as well as utilizing a combination of voice commands, gestures, and the location of the user to control a multitude of devices, such as turning on a particular light. Gestures or the user location are may be utilized to select the device to be controlled. Gestures may also be utilized to define the actions to be performed for the control of the selected device. Voice command may be utilized to further define the actions of the control. Voice command may also be utilized as a trigger for the activation of a control event to reduce the probability of false trigger, and also reduces the complexity of gestures.

The devices are defined by a data structure representing the 3D space together with the locations of the devices. Selection of the device may be a function of the time sequences of the 3D locations of the various parts of the human body, such as the eyes and the right index finger. The control action may also be a function of time sequences of likewise data, with the option of voice commands being input to the function.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an embodiment of a system 100.

FIG. 2 illustrates a wireless mesh network 200 in accordance with one embodiment.

FIG. 3 illustrates an embodiment of a system for integrating building automation with location awareness utilizing wireless mesh technology 300.

FIG. 4 illustrates an embodiment of a method 400.

FIG. 5 illustrates an embodiment of a method 500.

FIG. 6 illustrates an embodiment of an object selection diagram 600.

FIG. 7 illustrates an embodiment of an action gesture diagram 700.

FIG. 8 illustrates an embodiment of a multi-camera gesture system 800.

FIG. 9 illustrates a device group selection process 900 in accordance with one embodiment.

FIG. 10 illustrates a device group selection process 1000 in accordance with one embodiment.

FIG. 11 illustrates a gesture-based control 1100 in accordance with one embodiment.

FIG. 12 illustrates an embodiment of a wireless node 1202.

FIG. 13 is an example block diagram of a computing device 1300 that may incorporate embodiments of the present invention.

### DETAILED DESCRIPTION

“Action” refers to a change in the operational state of a device.

“Device data structures” refers to logic comprising a set of coordinates to define a specific 3D space, or volume, in an environment as the location of a specific device.

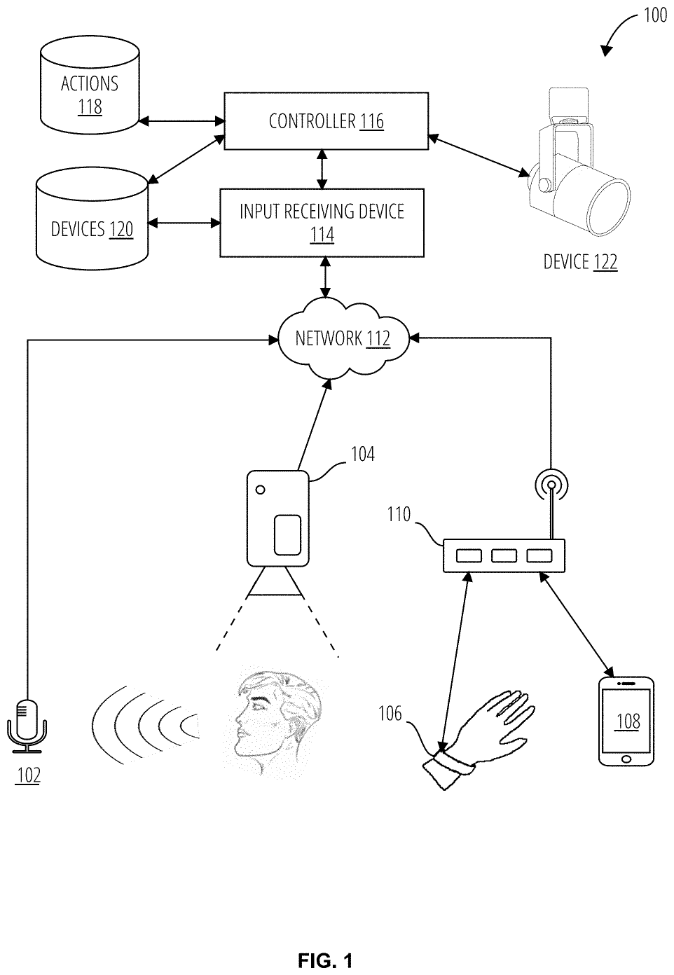

Referring to FIG. 1, a system 100 comprises an audio sensor 102, a motion sensor 104, a location device 106, a location device 108, a location sensor 110, a network 112, an input receiving device 114, a controller 116, an action control memory structure 118, a device control memory structure 120, and a device 122.

The audio sensor 102 receives audio inputs. The audio inputs may be atmospheric vibrations. The atmospheric vibrations may be converted into signals that are sent to the network 112, and further to the input receiving device 114. In some embodiments, the signals are sent to the input receiving device 114. The signals may then be determined to be voice commands. Voice command recognition, for example by utilizing an Alexa® device, may be utilized after a device is selected, to determine the actions to be taken. For example, the user may point to a light, then say “turn it on”, and that light will turn on. The audio sensor 102 may be a condenser microphone, a dynamic microphone, a ribbon microphone, a carbon microphone, a piezoelectric microphone, a fiber optic microphone, a laser microphone, a liquid microphone, a microelectrical-mechanical microphone, an omnidirectional microphone, a unidirectional microphone, a cardioid microphone, a hypercardioid microphone, a supercardioid microphone, a subcardioid microphone, a bi-directional microphone, a shotgun microphone, a parabolic microphone, a boundary microphone, etc.

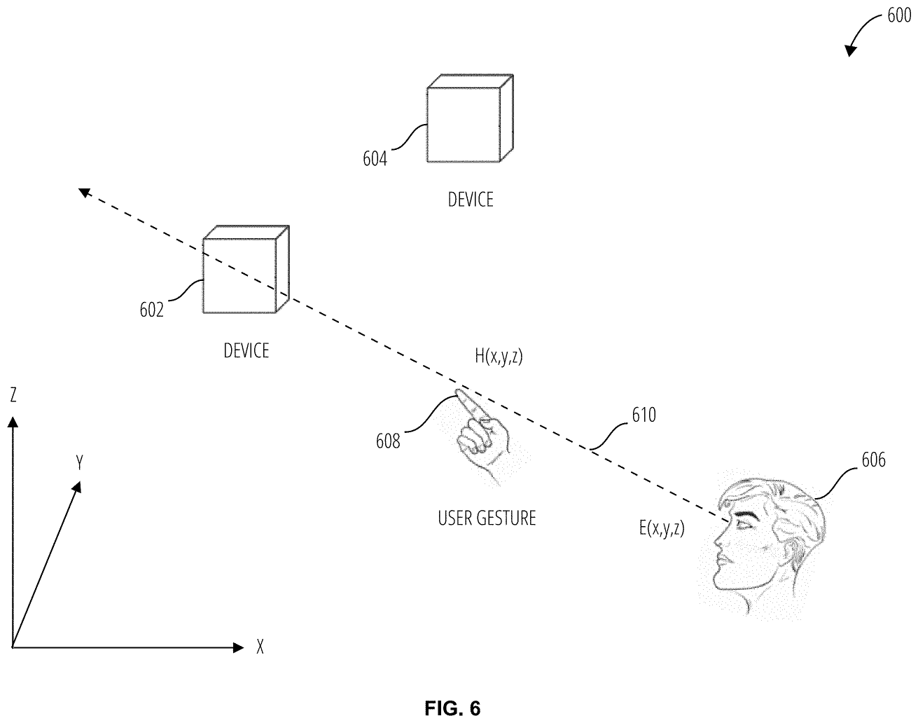

The motion sensor 104 receives environment inputs. The inputs may be electromagnetic waves, such as light, infrared, etc. The electromagnetic waves may be converted into signals that are sent to the network 112, and further to the input receiving device 114. In some embodiments, the signals are sent to the input receiving device 114. The signals may then be determined to be selection inputs or gestures (an action input). The signals may also be utilized to determine a user in the motion input. FIG. 6-FIG. 8 depict utilizing the motion sensor 104 to receive a selection input or an action input. The motion sensor 104 may not be utilized to determine the selection input or the action input, while another component, such as the input receiving device 114 or the controller 116 may be utilized to determine the selection input or the action input. The motion sensor 104 may be a digital camera, a camera module, a medical imaging device, a night vision device, a thermal imaging device, a radar device, a sonar device, a motion sensor, etc.

The location device 106 may be utilized to automatically identify and track the location of objects or people in real time, usually within a building or other contained area. Wireless real-time location system (RTLS) tags are attached to objects or worn by people (as depicted in FIG. 1), and in most RTLS, fixed reference points, such as the location sensor 110, receive wireless signals from tags to determine their location. The physical layer of RTLS technology may be radio frequency (RF) communication, but some systems utilize optical (usually infrared) or acoustic (usually ultrasound) technology instead of or in addition to RF. The location device 106 and the location sensor 110 may be transmitters, receivers, or both.

The location device 108 may utilize global positioning system (GPS) signals or to mobile phone tracking signals sent to the location sensor 110. The signal may be utilized by a local positioning system to determine the location of the location device 108.

The location sensor 110 receives location signals from the location device 106 and the location device 108. In some embodiments, the location sensor 110 determines a location based on the location signals. In other embodiments, the location sensor 110 sends the location signal to the network 112, or to the input receiving device 114. RTLS location may be determined by triangulation of signals transmitted by a location device 106, such as a depicted in FIG. 1. The location device 106 (or the location device 108) may be utilized to determine the user's location, such as being in a particular room, a voice command such as “turn light on” will turn on the lights in that room. From the location of the user, and their identity as associated with the location device 108, the user's permissions to carry out the action or actions on one or more devices selected by the gestures. Techniques for correlating user location and identity with permissions are known in the art and will not be further elaborated on.

In one embodiment, device selection may be achieved utilizing voice and RTLS location this way, and hand gestures may be for input of actions to be performed, and not utilized for the selection of the device. In other embodiments device selection is also made via gestures.

The network 112 may be a computer or server where data is accumulated, and computation applied to firstly detect pre-defined events such as hand gestures, location or voice commands, and secondly to apply algorithms that use these events as input and generate actions as output. The network 112 may be located remotely over the internet, or locally on-premise. The network 112 may receive signals from the audio sensor 102, the motion sensor 104, and the location sensor 110. These signals may be sent to the input receiving device 114. In some embodiments, the input receiving device 114, the controller 116, the action control memory structure 118, and the device control memory structure 120 are sub-components of the network 112.

The input receiving device 114 receives input signals from the audio sensor 102, the motion sensor 104, and the location sensor 110. The input signals may be received via the network 112, or the input receiving device 114 may be a sub-component of the network 112. The input receiving device 114 may determine whether the input signal is a selection input or an action input. The input receiving device 114 may communicate with the device control memory structure 120 to determine whether a signal is an input signal, and if so, whether the input signal is a selection input or an action input. The input receiving device 114 may also be configured to receive action inputs in response to receiving a selection input. After receiving the selection input, the input receiving device 114 may be configured to determine each input signal as an action input. This configuration may be for a pre-determined period of time, such as about three (3) seconds. The input receiving device 114 may include a timer to determine the amount of time that has elapsed. After the pre-determined period of time has elapsed, the input receiving device 114 may be reconfigured to revert to receiving selection inputs. The selection input and the action input are sent to the controller 116 to determine an action to be performed on a device 122. The input receiving device 114 may utilize the device data structures stored in the device control memory structure 120 to determine whether a selection input occured and to which device. The device data structures may include a set of vertices defining the devices location in the physical environment, which may be utilized for gestures and location information. Further, an identifier may be stored that may be compared to a received audio input signal, for voice commands.

The controller 116 receives the selection input or the action input from the input receiving device 114. The controller 116 determines an action from the action control memory structure 118 to perform on the associated device 122. The actions stored in the action control memory structure 118 may be influenced by the devices, such as the device 122, in communication with the controller 116 (such as via the network 112). The actions to be selected from may further be influence by the selection input, which may select a device stored in the action control memory structure 118, to filter the actions in the action control memory structure 118. The controller 116 generates a control signal that is sent to the device 122 to operate the device 122 in accordance with the action selected to be performed. The controller 116 may further communicate with and receive from the devices (including the device 122) the state of the devices. The state of the devices may influence the action to be determined by the controller 116. In one embodiment, the state filters the available actions to be selected. For example, the device 122, which is a light fixture, may be determined to be in an “OFF” state. Available action for the “OFF” state may be to operate the device 122 to turn “ON”. If the device 122 were in the “ON” state, available actions may include “OFF”, “DIM UP”, “DIM DOWN”, etc. Other actions may operate the device 122 in other ways, based on the type of device, which may include light fixtures, audio devices, computational devices, medical devices, etc. Other actions may include generating device data structures, which may be utilized to determine the device to be select, such as when utilizing pointing gestures. The actions may be utilized to determine the vertices of the selected device data structure. These may then be stored in the device control memory structure 120.

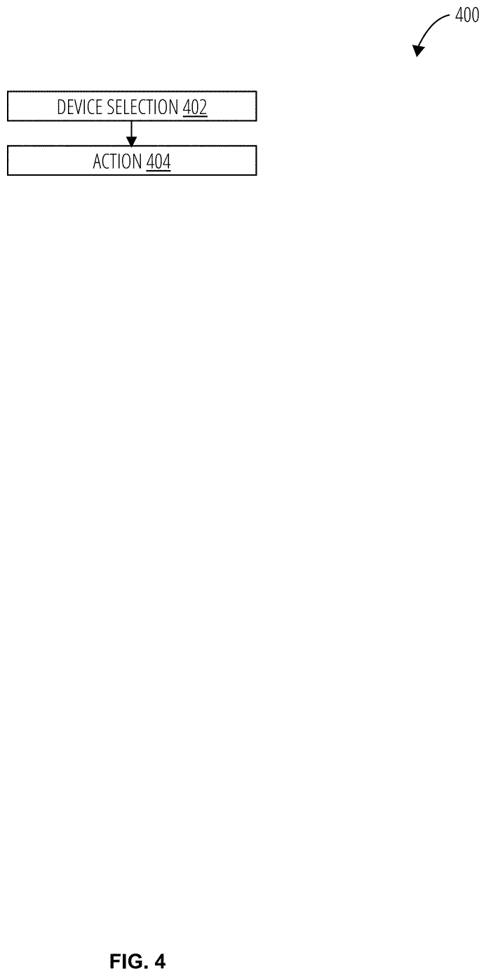

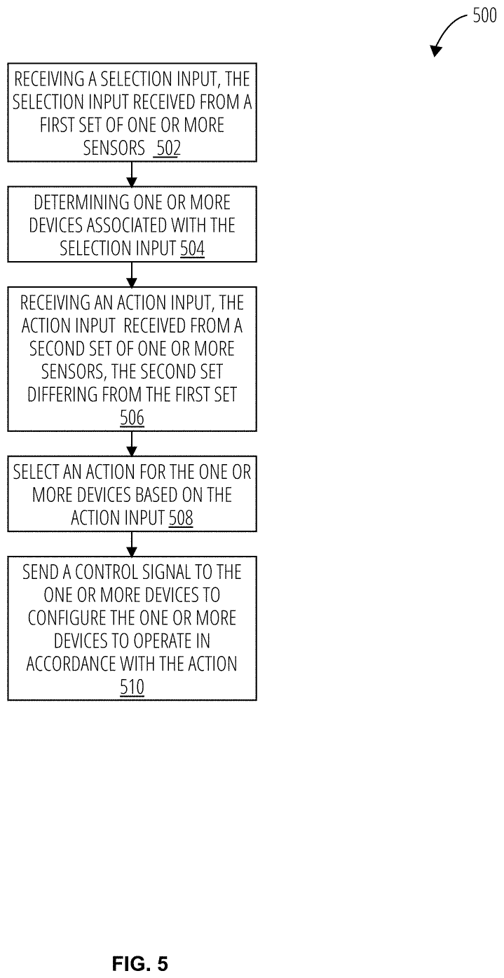

The system 100 may be operated in accordance with the processes depicted in FIG. 4 and FIG. 5.

The devices to control and/or group may be organized into a mesh network. A mesh network is a type of machine communication system in which each client node (sender and receiver of data messages) of the network also relays data for the network. All client nodes cooperate in the distribution of data in the network. Mesh networks may in some cases also include designated router and gateway nodes (e.g., nodes that connect to an external network such as the Internet) that are or are not also client nodes. The nodes are often laptops, cell phones, or other wireless devices. The coverage area of the nodes working together as a mesh network is sometimes called a mesh cloud.

Mesh networks can relay messages using either a flooding technique or a routing technique. Flooding is a routing algorithm in which every incoming packet, unless addressed to the receiving node itself, is forwarded through every outgoing link of the receiving node, except the one it arrived on. With routing, the message is propagated through the network by hopping from node to node until it reaches its destination. To ensure that all its paths remain available, a mesh network may allow for continuous connections and may reconfigure itself around broken paths. In mesh networks there is often more than one path between a source and a destination node in the network. A mobile ad hoc network (MANET) is usually a type of mesh network. MANETs also allow the client nodes to be mobile.

A wireless mesh network (WMN) is a mesh network of radio nodes. Wireless mesh networks can self-form and self-heal and can be implemented with various wireless technologies and need not be restricted to any one technology or protocol. Each device in a mobile wireless mesh network is free to move, and will therefore change its routing links among the mesh nodes accordingly.

Mesh networks may be decentralized (with no central server) or centrally managed (with a central server). Both types may be reliable and resilient, as each node needs only transmit as far as the next node. Nodes act as routers to transmit data from nearby nodes to peers that are too far away to reach in a single hop, resulting in a network that can span larger distances. The topology of a mesh network is also reliable, as each node is connected to several other nodes. If one node drops out of the network, due to hardware failure or moving out of wireless range, its neighbors can quickly identify alternate routes using a routing protocol.

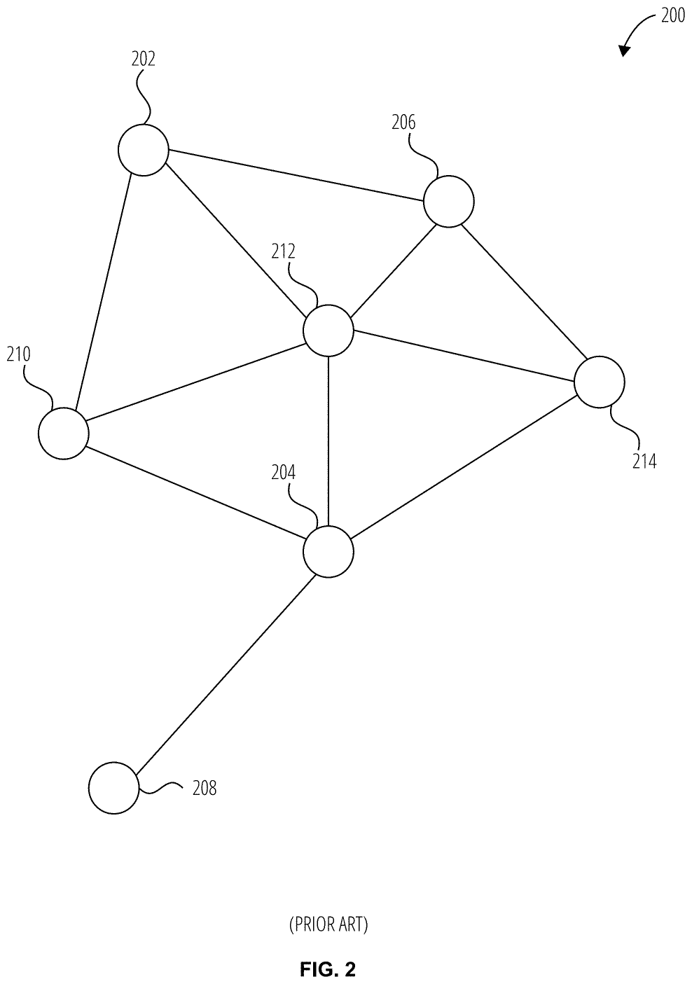

Referring to FIG. 2, an exemplary wireless mesh network 200 includes a control node 202, a router node 210, a router node 212, a router node 206, a router node 204, a gateway node 214, and a gateway node 208. The control node 202, the gateway node 214, and the gateway node 208 also operate as router nodes. Every node in the network participates in the routing of communications in the wireless mesh network 200. The gateway node 214 and gateway node 208 provide an interface between the wireless mesh network 200 and an external network, such as the Internet or a local area network. The control node 202 provides some level of centralized management for the wireless mesh network 200, and may be optional if each node acts autonomously to self-manage. One or more of the nodes may be fixed in location, some of the nodes may be mobile, or all of the nodes may be mobile.

In some conventional mesh networks, control and management is implemented utilizing remote transmitters (e.g., beacons) that emit an identifier to compatible receiving devices (mesh nodes), triggering delivery of a targeted push notification. These transmitters operate as part of a targeted notification system that includes a database of identifiers for each transmitter and targeted notifications. The emitted identifiers are unique to each transmitter, allowing the notification system to determine the location of the receiving device based on the location of the transmitter.

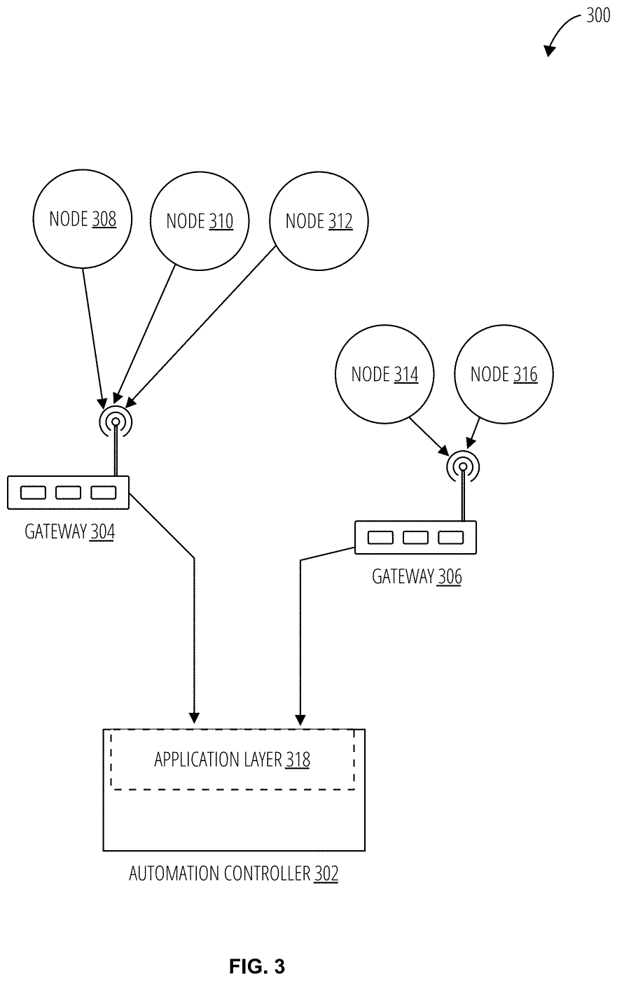

FIG. 3 illustrates an embodiment of a system for integrating building automation with location awareness utilizing wireless mesh technology 300, including a node 308, node 310, node 312, node 314, node 316, a gateway 304, a gateway 306, and application layer 318 and an automation controller 302. Such a system may be utilized to implement aspects of FIG. 1. For example the location device 106 may comprise an RFID and the controller 116 may comprise the automation controller 302. The input receiving device 114 may comprise one or more of the gateways, and the network 112 may comprise aspects of the wireless mesh network 200 such as the nodes, which may comprise the device or devices to control and group using gestures.

Referring to FIG. 4, a method 400 depicts the general procedure of operating the system 100. First, the device to be controlled is selected (block 402). The device may be selected by a gesture, a voice command, location recognition, or combination thereof. Secondly, the actions to be performed on the device are determined (block 404). The device may be selected by a gesture, a voice command, location recognition, or combination thereof. The method 400 may include a pre-determined period of time in which the action may be determined. After the pre-determined period of time elapses, the method 400 may determine inputs to be selection inputs.

Referring to FIG. 5, a method 500 receives a selection input (block 502). The selection input may be received from a first set of one or more sensors and may be a gesture, a voice command, location recognition, or combination thereof. The one or more devices associated with the selection input are determined (block 504). For example, a gesture may be determined to be pointing at a device by determining a ray from the gesture, determining whether the ray intercepts device data structures associated with the devices, and selecting the device. Multiple devices may also be selected. In one embodiment, the location may be utilized to select each device in at the location, such as a specific room. Additionally, a gesture may be utilized to select multiple objects. Such a gesture may include altering a ray to encircle multiple objects. An action input is received (block 506). The action input may be received from a second set of one or more sensors, which differ from the first set, and may be a gesture, a voice command, location recognition, or combination thereof. An action for the one or more devices is selected based on the action input (block 508). A control signal is sent to the one or more devices to configure the one or more devices to operate in accordance with the action (block 510).

In some embodiments, the selection input may also alter an input receiving device to be configured to receive the action input. The action may also be selected for the action input if the action input is received within a pre-determined period of time of the selection input. The action may be determined by determining one or more actions in an action control memory structure, filtering the one or more actions based on the devices selected, and selecting the action from the filtered actions. The action may also be determined by determining one or more actions in an action control memory structure, determining a first state of the devices selected, filtering the one or more actions based on the first state of the devices selected, and selecting the action from the filtered actions to alter the devices to a second state.

In another embodiment, the devices may be associated with device data structures stored in a device control memory structure, which may be generated by receiving the selection input associated with none of the devices, receiving the action input defining a 3D space associated with each of the device data structures, and storing the device data structures, the device data structures utilized to determine the devices selected by the selection input. The 3D space may be defined by receiving one or more gestures, determining rays based on each of the gestures, and determining vertices from each of the rays.

In yet another embodiment, a plurality of devices is selected based on the selection input by. A plurality of rays is determined to be associated with the selection input. The rays define a 3D structure. The plurality of devices is selected from the one or more devices in the device control memory structure. Each of the one or more devices may be defined by a 3D space based on the stored device data structures. The plurality of devices selected may have its 3D space within the 3D structure generated by the rays. For device partially included within the 3D structure, the device may be selected, not select, selected based on amount of 3D space within the 3D structure, etc.

Referring to FIG. 6, an object selection diagram 600 comprises a device 602, a device 604, a user location 606, a user gesture 608, and a ray 610.

The device 602 and the device 604 are each one defined by a set of 3D coordinates, which form the vertices of a polyhedral 3D space. The 3D space may be stored in a device control memory structure. The device 602 may be defined by:

Φ(A)={(x40,y40,zA0),(zA1,yA1,zA1) . . . (xAN,yAN,zAN)} Equation 1

and the device 604 may be defined by:

Φ(B)={(xB0,yB0,zB0),(xB1,yB1,zB1) . . . (xBN,yBN,zBN)} Equation 2

, where each point, (xN,yN,zN) is a vertex.

The user location 606 and the user gesture 608 each are identified by 3D coordinates. The user location 606 may be the eye position of the user, as defined by E(x,y,z). The user gesture 608 may be the user's finger position, as defined by H(x,y,z).

The ray 610 is determined by the user location 606 and the user gesture 608. The ray 610 may be a vector, EH, and defines the line of sight of the user. If the ray 610 intersects the 3D space Φ(A) or the 3D space Φ(B), the object is selected. Multiple objects may be in the path of the ray 610. The object with no other object in between may be selected in such a scenario.

Time-duration may be further applied to qualify selection. For example, the ray 610 may directed at the device for a pre-determined period of time before that object is selected. In some embodiments, the pre-determined period of time is about one (1) second. For example, that the pointing by the user needs to be at least 1 second to be qualified as a selection. A timer may be utilized to determine the amount of time elapsed while the ray 610 intersects a device.

In another embodiment, the selection of the devices may be based on encircling the objects with the ray 610. A gesture may alter the vector of the ray 610. The multiple vectors of the ray 610 may be utilized to form a 3D structure, such as a cone (which may be irregular in shape). The devices within this 3D structure may then be selected. For example, the ray 610 may be altered to form 3D structure that includes both the device 602 and the device 604. Both the device 602 and the device 604 may be selected in such a scenario. Selection may further depend on whether each device have similar actions that may be performed on the device. For devices without similar actions, the 3D structure may not select any device, select the devices with the most common set of actions, select a device based on usage of the devices, etc.

Video and image processing may be utilized to recognize the pointing action of a hand and finger and the location H(x,y,z) of the finger to determine the user gesture 608, and further image processing may be applied to recognize eye location, e.g., the coordinate E(x,y,z) of an eye, such as the right eye, to determine the user location 606. In some embodiments, the user gesture 608 may be first determined, and, upon successful determining the user gesture 608, the user location 606 may then be determined.

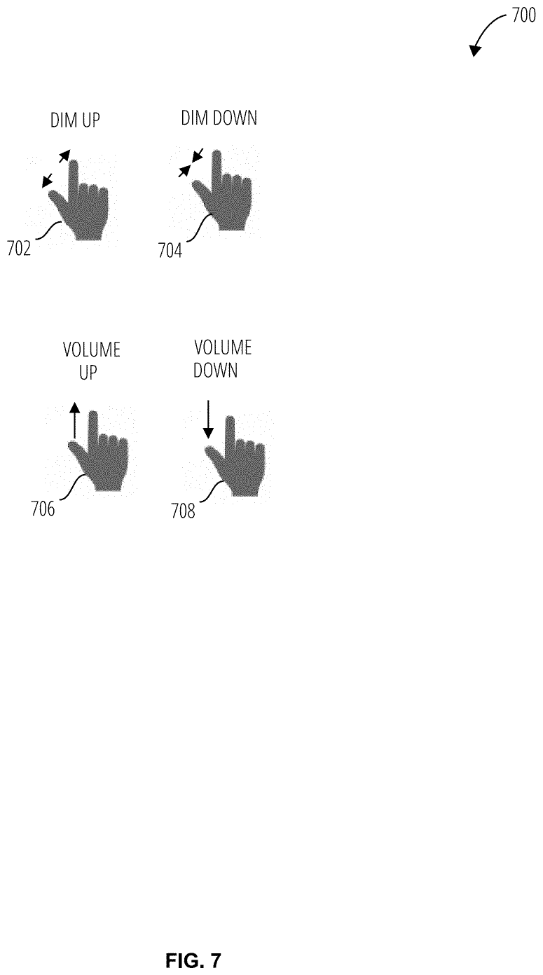

Referring to FIG. 7, an action gesture diagram 700 comprises a gesture 702, a gesture 704, a gesture 706, and a gesture 708. Control may be implemented by hand-gesture recognition, with each depicted gesture being an example of a possible action. Once device selection is successful, a visual or audio feedback may be provided. Exemplary feedback includes a beep from a speaker or flash of the light. The feedback may be given at the time that a timer is started. The timer may be utilized to determine if a pre-determined period of time has elapse. Then, the gesture recognition may be active for the pre-determined period of time, such as about three (3) seconds. During the time period, a video and image recognizer detects known gestures, such as the gesture 702, the gesture 704, the gesture 706, and the gesture 708. In some embodiments, the gesture 702 may be increasing the distance between a thumb and a first finger and be associated with dimming up a device. The gesture 704 may be decreasing the distance between a thumb and a first finger and be associated with dimming down a device. The gesture 706 may be detecting the motion of a thumb and first finger in an upward motion, for example, a positive change in the z-position as determined by an axis greater than a threshold value, and be associated with increasing the volume, such as audio decibel level, of a device. The gesture 708 may be detecting the motion of a thumb and first finger in a downward motion, for example, a negative change in the z-position as determined by an axis greater than a threshold value, and be associated with decreasing the volume, such as audio decibel level, of a device. The action is then applied to the device selected.

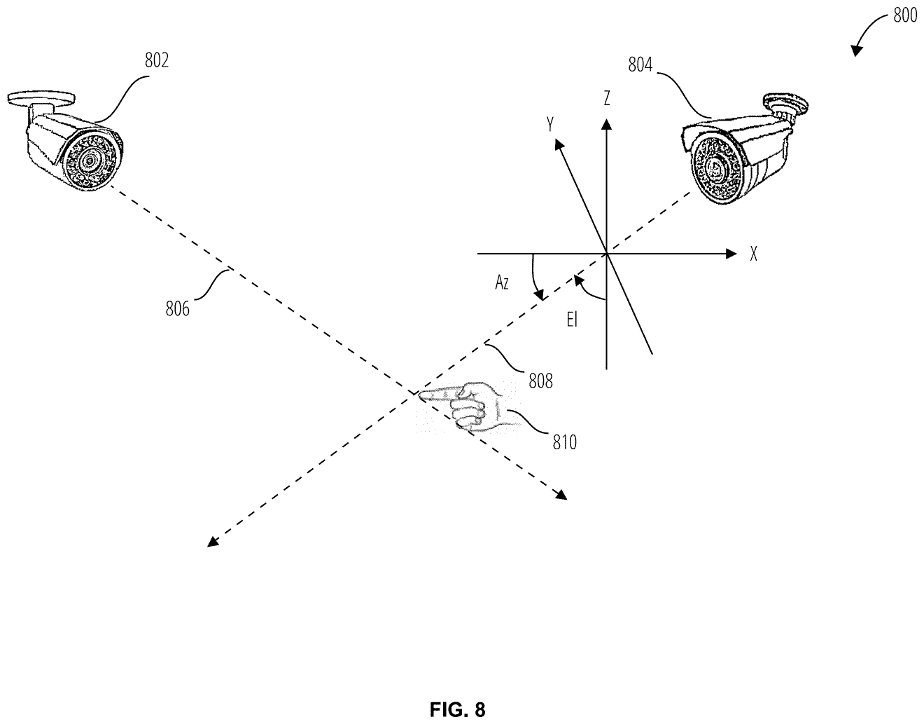

Referring to FIG. 8, a multi-camera gesture system 800 comprises a camera 802, a camera 804, a camera vector 806, a camera vector 808, and an object 810. Determination of the 3D locations (x,y,z) of the object 810 may be performed utilizing special 3D cameras or “depth sensors”, such as the camera 802 and the camera 804, which are prior art for acquisition of 3D spatial images. As depicted, each of the camera 802 and the camera 804 receive image data. The image data may be utilized to determine the position, (x,y,z), of the object 810. The camera 802 and the camera 804 are associated with the camera vector 806 and the camera vector 808, respectively. Each vector is defined by a starting point being the location of the camera, and the azimuth, Az, and elevation, E1, angles to intercept the object 810. The location is determined by the intersection of the vectors from the cameras, here, the camera vector 806 and the camera vector 808. The location of the object 810 may then be utilized to determine device selection or an action for a selected device.

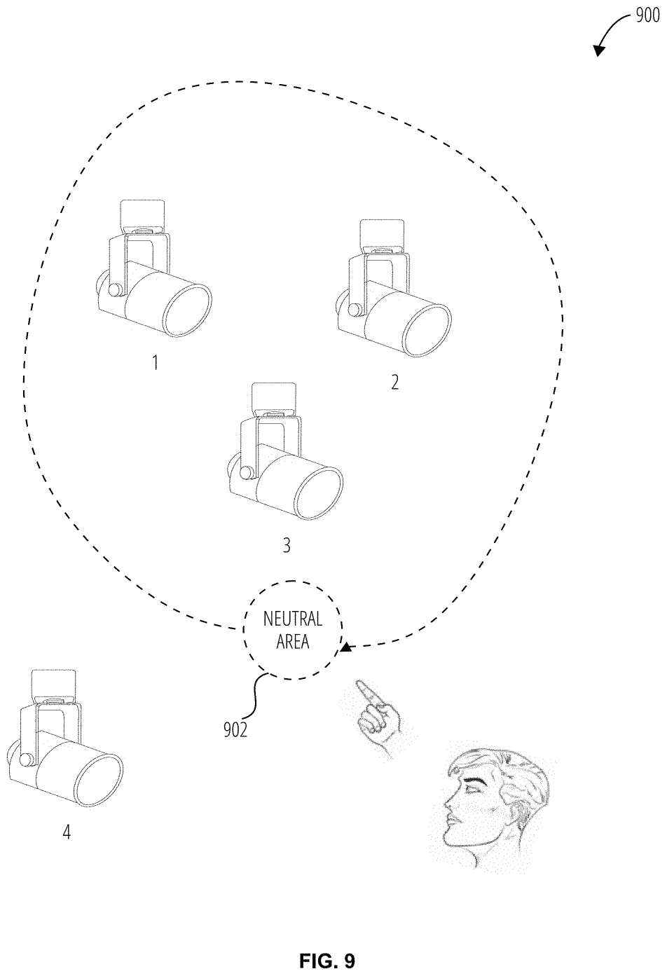

Referring now to FIG. 9, a device group selection process 900 for multiple devices such as lights is shown in one embodiment. A gesture such as the encircling of the devices by a finger as observed by the human subject, may be used to denote selection of a group of devices. This may be clearly defined by a first pointing to a neutral area 902 where there are no pre-identified objects, pausing for a determined time duration (e.g., three seconds) as previously described, and then proceed to perform a substantially encircling motion to the neutral area 902, and again pausing for a duration to denote completion of the device group selection process 900. In FIG. 9, the devices 1 to 3 are selected for grouping while device 4 is not.

The device group selection process 900 may be used to apply control, such as applying the same actions to a group of devices (e.g. Devices1-3 in FIG. 9) or to assign individual devices to logic groupings such as in the initial configuration of a lighting installation.

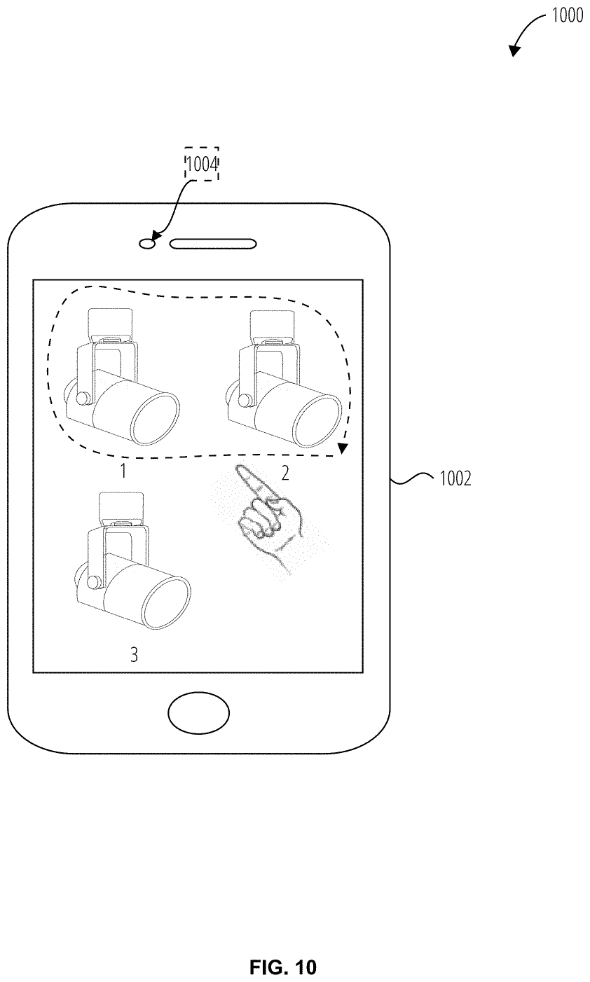

FIG. 10 illustrates a device group selection process 1000 in two embodiments. A mobile device 1002 may be utilized for grouping of devices for configuration or control. The mobile device 1002 may for example be a phone or tablet with a camera 1004, in which the devices to be controlled are depicted on the screen image, and the hand of the human subject may also be in the view of the camera 1004 and appear in the screen image. The gesture detection may be carried out as previously wherein encircling is carried out either on the screen image or around the devices themselves. FIG. 10 illustrates the example of selecting devices 1 and 2, and not device 3.

Instead of having the hand within the view of the camera 1004, in another embodiment the user carries out a substantially encircling contact gesture of the devices to group on the screen of the mobile device 1002.

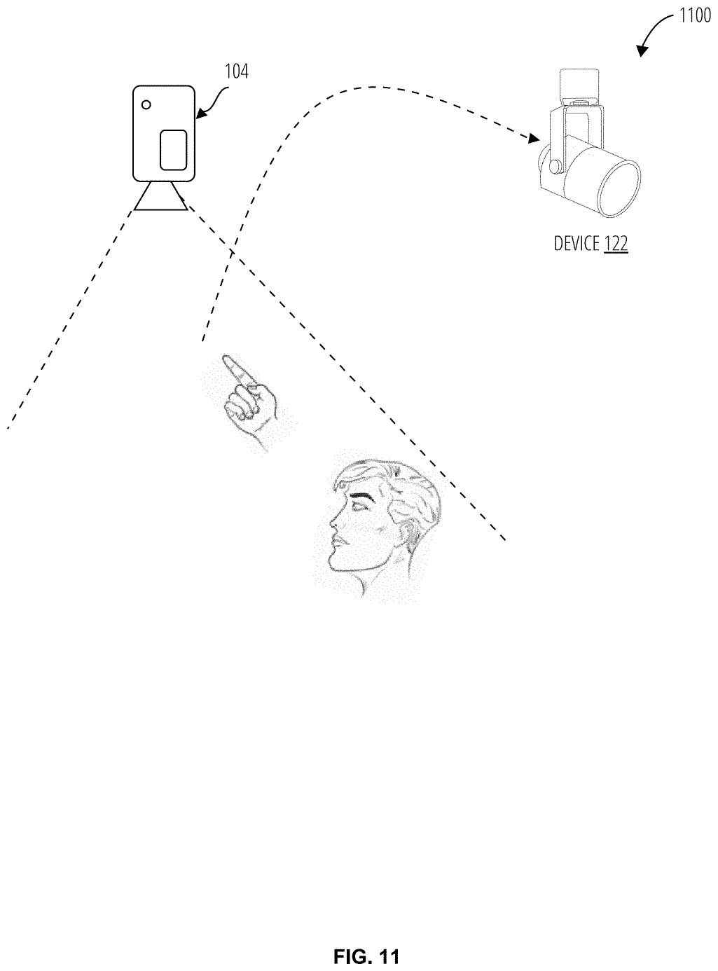

FIG. 11 illustrates a gesture-based control 1100 in one embodiment. Another use of gesture control is to associate one device to control another, such as during the initial configuration of a lighting installation. FIG. 11 illustrates a gesture whereby a device (e.g., motion sensor 104) is initially selected by pointing, and then applying a gesture to denote association (this could be any assigned gesture e.g., see FIG. 7), followed by gesturing an imaginary line connecting from the motion sensor 104 to a second device such as device 122. The group selection methods described previously may also be applied to form a group of devices to be controlled from one sensor. A mobile device may also be used to make the control association between sensors and single or groups of devices as previously described.

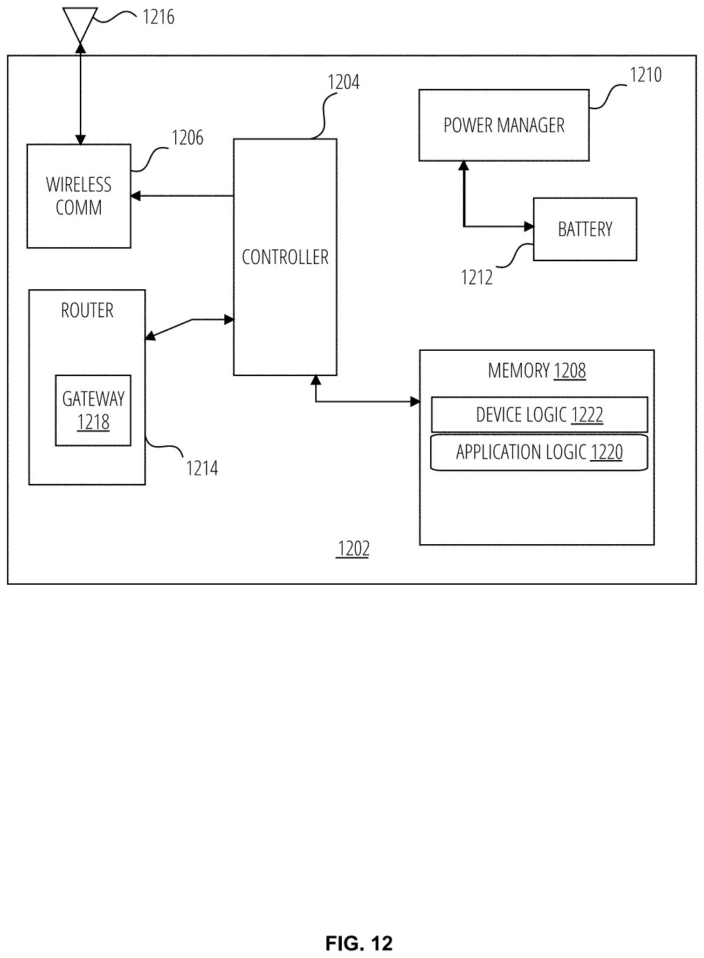

Referring to FIG. 12, a wireless node 1202 which may be a device in a wireless mesh network 200 includes an antenna 1216, a signal processing and system control 1204, a wireless communication 1206, a memory 1208, a power manager 1210, a battery 1212, a router 1214, a wireless node 1202, and a gateway 1218.

The signal processing and system control 1204 controls and coordinates the operation of other components as well as providing signal processing for the wireless node 1202. For example the signal processing and system control 1204 may extract baseband signals from radio frequency signals received from the wireless communication 1206 logic, and process baseband signals up to radio frequency signals for communications transmitted to the wireless communication 1206 logic. The signal processing and system control 1204 may comprise a central processing unit, digital signal processor, one or more controllers, or combinations of these components.

The wireless communication 1206 includes memory 1208 which may be utilized by the signal processing and system control 1204 to read and write instructions (commands) and data (operands for the instructions). The memory 1208 may include device logic 1222 and application logic 1220.

The router 1214 performs communication routing to and from other nodes of a mesh network (e.g., wireless mobile mesh network 100) in which the wireless node 1202 is utilized. The router 1214 may optionally also implement a network gateway 1218.

The components of the wireless node 1202 may operate on power received from a battery 1212. The battery 1212 capability and energy supply may be managed by a power manager 1210.

The wireless node 1202 may transmit wireless signals of various types and range (e.g., cellular, Wi-Fi, Bluetooth, and near field communication i.e. NFC). The wireless node 1202 may also receive these types of wireless signals. Wireless signals are transmitted and received using wireless communication 1206 logic coupled to one or more antenna 1216. Other forms of electromagnetic radiation may be used to interact with proximate devices, such as infrared (not illustrated).

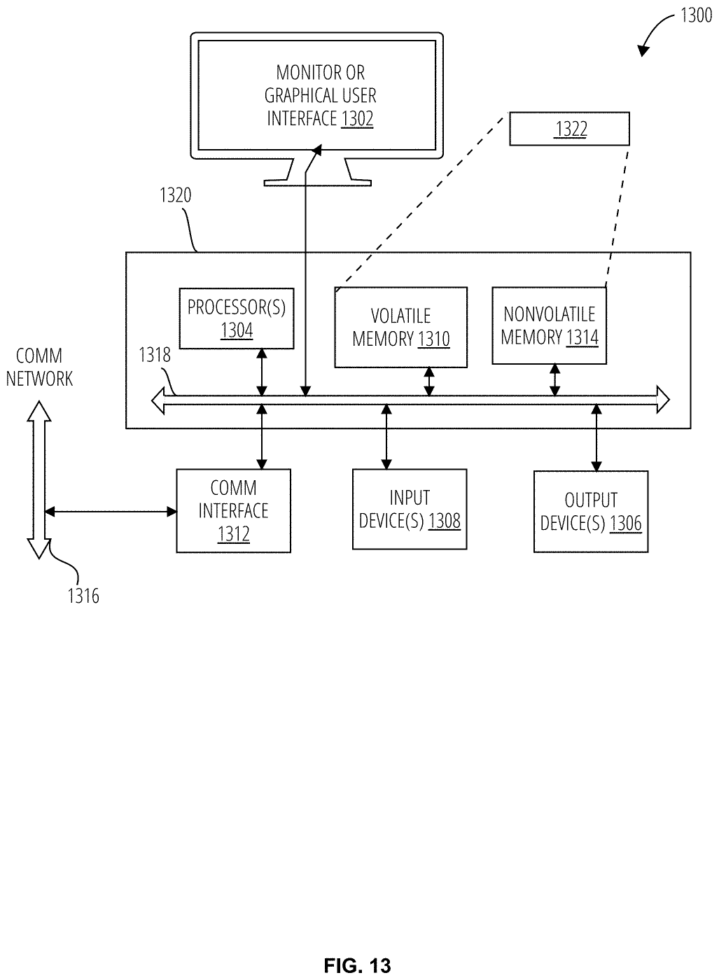

FIG. 13 is an example block diagram of a computing device 1300 that may incorporate embodiments of the present invention, such as a management console and/or controller 116. FIG. 13 is merely illustrative of a machine system to carry out aspects of the technical processes described herein, and does not limit the scope of the claims. One of ordinary skill in the art would recognize other variations, modifications, and alternatives. In one embodiment, the computing device 1300 typically includes a monitor or graphical user interface 1302, a data processing system 1320, a communication network interface 1312, input device(s) 1308, output device(s) 1306, and the like.

As depicted in FIG. 13, the data processing system 1320 may include one or more processor(s) 1304 that communicate with a number of peripheral devices via a bus subsystem 1318. These peripheral devices may include input device(s) 1308, output device(s) 1306, communication network interface 1312, and a storage subsystem, such as a volatile memory 1310 and a nonvolatile memory 1314.

The volatile memory 1310 and/or the nonvolatile memory 1314 may store computer-executable instructions and thus forming logic 1322 that when applied to and executed by the processor(s) 1304 implement embodiments of the processes disclosed herein.

The input device(s) 1308 include devices and mechanisms for inputting information to the data processing system 1320. These may include a keyboard, a keypad, a touch screen incorporated into the monitor or graphical user interface 1302, audio input devices such as voice recognition systems, microphones, and other types of input devices. In various embodiments, the input device(s) 1308 may be embodied as a computer mouse, a trackball, a track pad, a joystick, wireless remote, drawing tablet, voice command system, eye tracking system, and the like. The input device(s) 1308 typically allow a user to select objects, icons, control areas, text and the like that appear on the monitor or graphical user interface 1302 via a command such as a click of a button or the like.

The output device(s) 1306 include devices and mechanisms for outputting information from the data processing system 1320. These may include the monitor or graphical user interface 1302, speakers, printers, infrared LEDs, and so on as well understood in the art.

The communication network interface 1312 provides an interface to communication networks (e.g., communication network 1316) and devices external to the data processing system 1320. The communication network interface 1312 may serve as an interface for receiving data from and transmitting data to other systems. Embodiments of the communication network interface 1312 may include an Ethernet interface, a modem (telephone, satellite, cable, ISDN), (asynchronous) digital subscriber line (DSL), FireWire, USB, a wireless communication interface such as Bluetooth or Wi-Fi, a near field communication wireless interface, a cellular interface, and the like.

The communication network interface 1312 may be coupled to the communication network 1316 via an antenna, a cable, or the like. In some embodiments, the communication network interface 1312 may be physically integrated on a circuit board of the data processing system 1320, or in some cases may be implemented in software or firmware, such as “soft modems”, or the like.

The computing device 1300 may include logic that enables communications over a network using protocols such as HTTP, TCP/IP, RTP/RTSP, IPX, UDP and the like.

The volatile memory 1310 and the nonvolatile memory 1314 are examples of tangible media configured to store computer readable data and instructions to implement various embodiments of the processes described herein. Other types of tangible media include removable memory (e.g., pluggable USB memory devices, mobile device SIM cards), optical storage media such as CD-ROMS, DVDs, semiconductor memories such as flash memories, non-transitory read-only-memories (ROMS), battery-backed volatile memories, networked storage devices, and the like. The volatile memory 1310 and the nonvolatile memory 1314 may be configured to store the basic programming and data constructs that provide the functionality of the disclosed processes and other embodiments thereof that fall within the scope of the present invention.

Logic 1322 that implements embodiments of the present invention may be stored in the volatile memory 1310 and/or the nonvolatile memory 1314. Said logic 1322 may be read from the volatile memory 1310 and/or nonvolatile memory 1314 and executed by the processor(s) 1304. The volatile memory 1310 and the nonvolatile memory 1314 may also provide a repository for storing data used by the logic 1322.

The volatile memory 1310 and the nonvolatile memory 1314 may include a number of memories including a main random access memory (RAM) for storage of instructions and data during program execution and a read only memory (ROM) in which read-only non-transitory instructions are stored. The volatile memory 1310 and the nonvolatile memory 1314 may include a file storage subsystem providing persistent (non-volatile) storage for program and data files. The volatile memory 1310 and the nonvolatile memory 1314 may include removable storage systems, such as removable flash memory.

The bus subsystem 1318 provides a mechanism for enabling the various components and subsystems of data processing system 1320 communicate with each other as intended. Although the communication network interface 1312 is depicted schematically as a single bus, some embodiments of the bus subsystem 1318 may utilize multiple distinct busses.

It will be readily apparent to one of ordinary skill in the art that the computing device 1300 may be a device such as a smartphone, a desktop computer, a laptop computer, a rack-mounted computer system, a computer server, or a tablet computer device. As commonly known in the art, the computing device 1300 may be implemented as a collection of multiple networked computing devices. Further, the computing device 1300 will typically include operating system logic (not illustrated) the types and nature of which are well known in the art.

Terms used herein should be accorded their ordinary meaning in the relevant arts, or the meaning indicated by their use in context, but if an express definition is provided, that meaning controls.

“Circuitry” refers to electrical circuitry having at least one discrete electrical circuit, electrical circuitry having at least one integrated circuit, electrical circuitry having at least one application specific integrated circuit, circuitry forming a general purpose computing device configured by a computer program (e.g., a general purpose computer configured by a computer program which at least partially carries out processes or devices described herein, or a microprocessor configured by a computer program which at least partially carries out processes or devices described herein), circuitry forming a memory device (e.g., forms of random access memory), or circuitry forming a communications device (e.g., a modem, communications switch, or optical-electrical equipment).

“Firmware” refers to software logic embodied as processor-executable instructions stored in read-only memories or media.

“Hardware” refers to logic embodied as analog or digital circuitry.

“Logic” refers to machine memory circuits, non transitory machine readable media, and/or circuitry which by way of its material and/or material-energy configuration comprises control and/or procedural signals, and/or settings and values (such as resistance, impedance, capacitance, inductance, current/voltage ratings, etc.), that may be applied to influence the operation of a device. Magnetic media, electronic circuits, electrical and optical memory (both volatile and nonvolatile), and firmware are examples of logic. Logic specifically excludes pure signals or software per se (however does not exclude machine memories comprising software and thereby forming configurations of matter).

“Software” refers to logic implemented as processor-executable instructions in a machine memory (e.g. read/write volatile or nonvolatile memory or media).

Herein, references to “one embodiment” or “an embodiment” do not necessarily refer to the same embodiment, although they may. Unless the context clearly requires otherwise, throughout the description and the claims, the words “comprise,” “comprising,” and the like are to be construed in an inclusive sense as opposed to an exclusive or exhaustive sense; that is to say, in the sense of “including, but not limited to.” Words using the singular or plural number also include the plural or singular number respectively, unless expressly limited to a single one or multiple ones. Additionally, the words “herein,” “above,” “below” and words of similar import, when used in this application, refer to this application as a whole and not to any particular portions of this application. When the claims use the word “or” in reference to a list of two or more items, that word covers all of the following interpretations of the word: any of the items in the list, all of the items in the list and any combination of the items in the list, unless expressly limited to one or the other. Any terms not expressly defined herein have their conventional meaning as commonly understood by those having skill in the relevant art(s).

Various logic functional operations described herein may be implemented in logic that is referred to using a noun or noun phrase reflecting said operation or function. For example, an association operation may be carried out by an “associator” or “correlator”. Likewise, switching may be carried out by a “switch”, selection by a “selector”, and so on.

What is claimed is:

1. A system comprising:
an input receiving device to:
receive a selection input from an image sensor during a first pre-determined period of time; and
receive an action input from the image sensor during a second pre-determined period of time; and
a controller to:
select a plurality of devices of a mesh network based on the selection input, the selection input comprising a plurality of rays defining a 3D structure, the plurality of devices each being defined by a 3D space, the controller selecting each device with the 3D space within the 3D structure;
select an action for the plurality of devices based on the action input; and
send a control signal to the plurality of devices to configure the plurality of devices to operate as a group in accordance with the action.

2. The system of claim 1, wherein the input receiving device is configured to a state in which to accept the action input in response to the selection input.

3. The system of claim 2, wherein the input receiving device is configured to receive the action input during the second pre-determined period of time, the input receiving device configured to revert to receiving the selection input after the second pre-determined period of time has elapsed.

4. The system of claim 1, wherein the selection input comprises a substantially encircling gesture in free space.

5. The system of claim 1, wherein the selection input comprises a substantially encircling gesture applied to a live camera image of the plurality of devices.

6. The system of claim 1, wherein the selection input is a gesture, the sensors are one or more cameras, the controller determining the one or more devices by determine a ray from the gesture to intersect the one or more devices to select the one or more devices.

7. The system of claim 1, wherein the action is selected from one or more actions in an action control memory structure, the devices selected influencing the one or more actions available for selection.

8. The system of claim 1, wherein the controller is further configured to:
determine a first state of the devices;
influence the action selected from the action input by the first state of the devices; and
alter the devices to a second state with the control signal based on permissions associated with a location signal received by a user-carried device.

9. The system of claim 1, wherein the devices are associated with device data structures stored in a device control memory structure, the controller configured to generate the device data structures in response to receiving the action input, the action input defining a 3D space associated with each of the device data structures.

10. The system of claim 9, wherein the action input comprises one or more gestures received by one or more cameras, the controller to determine vertices of the 3D space based on rays associated with the one or more gestures.

11. A method comprising:
receiving a selection input, the selection input received from a first set of one or more sensors;
selecting a plurality of devices of a mesh network associated with the selection input by:
determining a plurality of rays associated with the selection input;
defining a 3D structure from the plurality of rays; and
selecting the plurality of devices from the one or more devices, each of the one or more devices being defined by a 3D space, the plurality of devices selected having the 3D space within the 3D structure;
receiving an action input, the action input received from a second set of one or more sensors, the second set differing from the first set;
select an action for the one or more devices based on the action input and a location signal received from a third set of one or more sensors; and
send a control signal to the one or more devices to configure the one or more devices to operate in accordance with the action.

12. The method of claim 11, wherein the selection input alters an input receiving device to be configured to receive the action input.

13. The method of claim 12, wherein the action is selected for the action input if the action input is received within a pre-determined period of time of the selection input.

14. The method of claim 11, wherein the selection input comprises one or more of gestures, voice commands, and locations.

15. The method of claim 11, wherein the action input is based on a combination of all of gestures, voice commands, and locations.

16. The method of claim 11, wherein the selection input is a gesture received by one or more cameras, further comprising:
determining a ray from the gesture;
determining whether the ray intercepts device data structures associated with the one or more devices; and
selecting the one or more devices.

17. The method of claim 11, further comprising:
determining one or more actions in an action control memory structure;
filtering the one or more actions based on the one or more devices selected; and
selecting the action from the filtered actions.

18. The method of claim 11, further comprising:
determining one or more actions in an action control memory structure;
determining a first state of the devices selected;
filtering the one or more actions based on the first state of the devices selected; and
selecting the action from the filtered actions to alter the devices to a second state.

19. The method of claim 11, wherein the devices are associated with device data structures stored in a device control memory structure, the device data structures generated by:
receiving the selection input associated with none of the devices;
receiving the action input defining a 3D space associated with each of the device data structures; and
storing the device data structures, the device data structures utilized to determine the devices selected by the selection input.

20. The method of claim 19, wherein the 3D space defined by:
receiving one or more gestures;
determining rays based on each of the gestures; and
determining vertices from each of the rays.
